(19) United States
(12) Patent Application Publication
(10) Pub. No.: US 2003/0233463 A1
(43) Pub. Date: Dec. 18, 2003

(54) Network device operation and control

(76) Inventor: Neil O'Connor, Lackagh (IE)

Correspondence Address: William M. Lee, Jr., Lee, Mann, Smith, McWilliams, Sweeney & Ohlson, P.O. Box 2786, Chicago, IL, 60690-2786, US

(21) Appl. No.: 10/171,742

(22) Filed: Jun. 14, 2002

(51) Int. Cl. G06F 15/16

(52) U.S. Cl. 709/230

(57) ABSTRACT

A method of operating a network device having a communications protocol stack for communication with other devices via a packet-based network, in which the protocol stack including at least a media access layer and one or more higher layers. The method includes the steps of: receiving a packet at the media access layer of the device; analysing said packet to identify a characteristic indicative that the packet includes a media access layer instruction; and upon identification of said characteristic, executing a procedure at the media access layer in accordance with the instruction contained in the packet without passing said packet to a higher layer.

### FIELD OF THE INVENTION

This invention relates to the operation and control of networked devices.

### BACKGROUND ART

Devices in a network communicate with one another using network addresses as part of a suite of communications protocols. The protocols are usually implemented in the device by a protocol stack which controls how data is passed between an application layer on one device and that on another device.

The application layer data is passed through the lower layers before being transmitted over the network in packets and when each packet reaches its destination it is passed up through the stack on the remote device to the application layer of that device.

One of the commonest protocols is the transmission control protocol/internet protocol (TCP/IP) which is becoming universal for the transmission of many types of data over local and wide area networks. TCP/IP resides in layers 3 and 4 of the protocol stack (using the standard OSI 7 layer model). In a local area network (LAN), the TCP/IP packets are passed to layers 1 and 2 for transmission. Ethernet is a common layer 2 implementation. Other protocols may be used to transmit the data received from layer 2, and the invention concerns itself particularly with layer 2 (data link layer or media access control (MAC) layer) hardware and software.

One of the most serious problems which can occur in communications between devices over a network is a broadcast storm. Various network protocols allow packets of data to be broadcast to the entire network. Such packets are received by each device and passed up through the stack to resolve the IP address. While such broadcasts are very useful facilities, they can be problematic if a device begins to broadcast packets continuously due to an error in the application running in the device or in the protocol stack.

Typically such a broadcast storm may result in a single device transmitting e.g. 20,000 packets per second, each of which must be resolved and discarded by every-other device on the network receiving the packet. This often means all of the devices connected to a particular router to the rest of the network, since such routers may be configured not to pass broadcast messages to the larger network. Even with such safeguards in place, a broadcast storm can result in the entire section of network up to the router being rendered inactive due to the activity of the malfunctioning device consuming the stack resources of all of the other devices in that section of the network.

When such a broadcast storm occurs, the conventional solution is to inspect each device to determine whether it is the source of the storm and to physically reset the device or disconnect it from the network. It is frequently the case, however, that physical access to the devices may be difficult to obtain, due to geographical separation between the various devices, the time of day (e.g. late at night when fewer support staff are available) or due to the remoteness of the support staff from the area of network experiencing difficulty.

There can also be a difficulty in remotely determining the source of the broadcast storm, if all of the machines receiving the broadcasts are rendered inactive to a greater or lesser extent by the storm. In such cases layers 3 and 4 of the stack of each device can be unresponsive to remote access methods such as telnet, FTP or rlogin, preventing access by a remote user or a remote program to higher layer applications (such as diagnostic, operating system or program control applications).

The present invention is not simply concerned with broadcast storms, though these are provided as an example of one of the most serious network problems due to a malfunctioning device. Other less dramatic problems may cause the same difficulties in terms of ease of access and inability to access higher level programs remotely, even if the stack has simply become unresponsive on a simple machine due to a program error.

### SUMMARY OF THE INVENTION

The invention provides a method of operating a network device. The device has a communications protocol stack for communication with other devices via a packet-based network, and the protocol stack includes at least a media access layer and one or more higher layers. The method involves the following steps:

receiving a packet at the media access layer of the device;

analysing the packet to identify a characteristic which indicates that the packet includes an instruction for interpretation by the media access layer; and

on identifying this characteristic, executing a procedure at the media access layer in accordance with the instruction without passing the packet to a higher layer.

The method provides the advantage that devices whose protocol stacks or running applications are for the most part unresponsive (such as in the case of a device creating a broadcast storm) will often nevertheless have a functioning media access layer (due to the fact that the lower layers of the stack are generally more robust than higher layers). By taking advantage of the robustness of the media access layer, instructions can be executed by this layer to alter the functioning of the device, and thereby possibly terminating the problem.

The procedure for execution preferably involves writing one or more bits to a register of the device.

Preferably, in such cases, writing the bit(s) causes a processor of the device to vary the operation of the device, such as by:

the processor executing a device restart,

the processor stopping the transmission of packets from the protocol stack,

the processor terminating an executing application procedure running on the device.

the processor jumping to a different instruction of an executing application procedure running on the device.

In a preferred embodiment the method is repeated to identify a pair of related packets each containing a media access layer instruction, such that the first packet of the pair causes the media access layer of the device to await the second packet of the pair, and the second packet causes the media access layer to execute a further procedure (e.g. device restart, transmission stop, etc.), whereby both packets of the pair must be received for the further procedure to be executed.

The waiting procedure can be effected by starting a timer and monitoring received packets to identify the second packet before a predetermined timeout period has elapsed.

The characteristic indicating that the packet includes a media access layer instruction is preferably a port number not corresponding to an open port of the device, and is preferably a predetermined port number used exclusively as the characteristic indicator.

In other words, the media access layer may be designed to intercept packets addressed to port 5001 (say) and to look in such packets for media access layer instructions.

Alternatively, the characteristic can simply be the instruction itself which is readable by the media access layer and contained in the datagram of the packet.

The invention also provides a network device having:

a communications protocol stack for communication with other devices via a packet-based network, the protocol stack including at least a media access layer and one or more higher layers,

the media access layer including a discrimination module for discriminating between received communications packets for passing to a higher layer and received instruction packets for processing at the media access layer on the basis of a characteristic indicative that the packet includes a media access layer instruction; and

the media access layer further including a processing circuit for processing instructions received in instruction packets to thereby vary the operation of the device without passing the instruction packets to a higher layer.

The processing circuit is preferably operatively linked to a register of the device, so that by changing a value of the register one causes a variation in the operation of the device.

The device preferably also includes a timer circuit in communication with the discrimination module, whereby the discrimination module can measure the time between receipt of a pair of packets each containing a media access layer instruction.

The invention also provides a computer program for execution on a network device of the type having a communications protocol stack including at least a media access layer and one or more higher layers, the program being effective when executed to cause the device to:

analyse a packet received at the media access layer of the device to identify a characteristic indicative that the packet includes a media access layer instruction; and

upon identification of the characteristic, execute a procedure at the media access layer in accordance with the instruction contained in the packet without passing the packet to a higher layer.

The invention provides, in a further aspect, a method of diagnosing a network device having a communications protocol stack including at least a media access layer and one or more higher layers, the method comprising:

sending a packet to the device, the packet including a media access layer instruction which causes the media access layer to automatically issue to a remote address on the network a response including information for use in a diagnosis of the device;

receiving at the remote address the response from the device; and

analysing the information to diagnose the network device.

In this aspect of the invention, the ability to identify a packet containing an instruction is employed to cause the media access layer to transmit status information which allows a remote apparatus (preferably but not necessarily the apparatus which sent the packet to the network device) to diagnose the device remotely. This is particularly useful where a diagnostic apparatus is on a part of the network not affected by a broadcast storm, and this diagnostic method can be used to determine which device is causing the storm.

Preferably, the information in the response comprises a traffic report relating to outbound traffic from the device.

Further, preferably, the step of analysing comprises determining if the volume of outbound traffic from the device is greater than a predetermined limit.

The steps of this method can be repeated for a number of devices on the network, so that the offending device can be identified by examining traffic reports from each device in turn.

The invention further provides a method of diagnosing a network device having a communications protocol stack which includes a media access layer and one or more higher layers, this method comprising:

sending a first packet to the network device via the network at a first time and a second packet to the network device at a second, later time, the packets each including a media access layer instruction to which the media access layer is responsive, the instructions causing the media access layer to automatically issue to a remote address on the network a response to each packet including information for use in a diagnosis of the device;

receiving at the remote address a response from the device to the first packet and a response to the second packet; and

analysing the information in the responses to diagnose the network device based on the change in information between the first and second responses.

This method is useful where packets issued from a device are sequentially numbered. By comparing the packet numbers last issued from a device at two closely separated times, an estimate can be made of the numbers of packets being broadcast per unit time (it may be possible to look at only broadcast packets or at all packets), and in this way any unusual behaviour can be identified.

The invention further provides an apparatus for diagnosing a network device, wherein the device being diagnosed has a communications protocol stack for communication with other devices via a packet-based network, the protocol stack including at least a media access layer and one or more higher layers, the apparatus comprising:

a packet generator for generating a packet including a media access layer instruction to which the media access layer of the network device is responsive, the instruction being adapted to cause the media access layer to automatically issue to a remote address on the network a response including information for use in a diagnosis of the device;

a memory for capturing at the remote address the response from the device; and

a processor for analysing the information to diagnose the network device.

In a further aspect there is provided a computer program for execution on a diagnostic apparatus which causes the apparatus to:

send a packet to a network device via the network, the packet including a media access layer instruction to which the media access layer is responsive, the instruction causing the media access layer to automatically issue to a remote address on the network a response including information for use in a diagnosis of the device;

receive at the remote address the response from the device; and

analyse the information to diagnose the network device.

The invention provides, in a further aspect a method of remotely controlling a device over a network, the device having a communications protocol stack for communication with other devices via a packet-based network, and the protocol stack including at least a media access layer and one or more higher layers, wherein the method comprises:

generating a packet including a media access layer instruction for interpretation by the media access layer of the network device and a characteristic indicative to the media access layer that the packet includes an instruction for interpretation by the media access layer; and

sending said packet to said network device.

In another aspect there is provided an apparatus for remotely controlling a network device having a communications protocol stack for communication with other devices via a packet-based network, and the protocol stack including at least a media access layer and one or more higher layers, wherein the apparatus comprises:

a packet generator for generating a packet including a media access layer instruction for interpretation by the media access layer of the network device and a characteristic indicative to the media access layer that the packet includes an instruction for interpretation by the media access layer; and

a network connection for sending the packet to the network device.

In another aspect there is provided an electrical signal comprising a packet for transmission across a packet-based network, the packet including an instruction for interpretation by the media access layer of a receiving device effective to cause the media access layer to execute a procedure without passing the instruction to a higher layer.

The invention provides, in another aspect, a packet based network comprising a network device, the network device comprising:

a communications protocol stack for communication with other devices via a packet-based network, the protocol stack including at least a media access layer and one or more higher layers,

the media access layer comprising a discrimination module for discriminating between received communications packets for passing to a higher layer and received instruction packets for processing at the media access layer on the basis of a characteristic indicative that the packet includes a media access layer instruction; and

the media access layer further comprising a processing circuit for processing instructions received in instruction packets to thereby vary the operation of the device without passing the instruction packets to a higher layer.

The packet packet-based network can also include a diagnostic apparatus for diagnosing the network device as described hereinbefore.

### BRIEF DESCRIPTION OF THE DRAWINGS

FIG. 1 is a diagram of a telephony system architecture in which the present invention is implemented;

FIG. 2 is a block diagram of the functional components of an Internet Telephony Gateway (ITG) card according to the present invention;

FIG. 3 is a flowchart illustrating the operation of a first method and computer program according to the invention;

FIG. 4 is a flowchart illustrating the operation of a second method and computer program according to the invention; and

FIG. 5 is a flowchart illustrating the operation of a third method and computer program according to the invention.

### DETAILED DESCRIPTION OF BEST MODE(S)

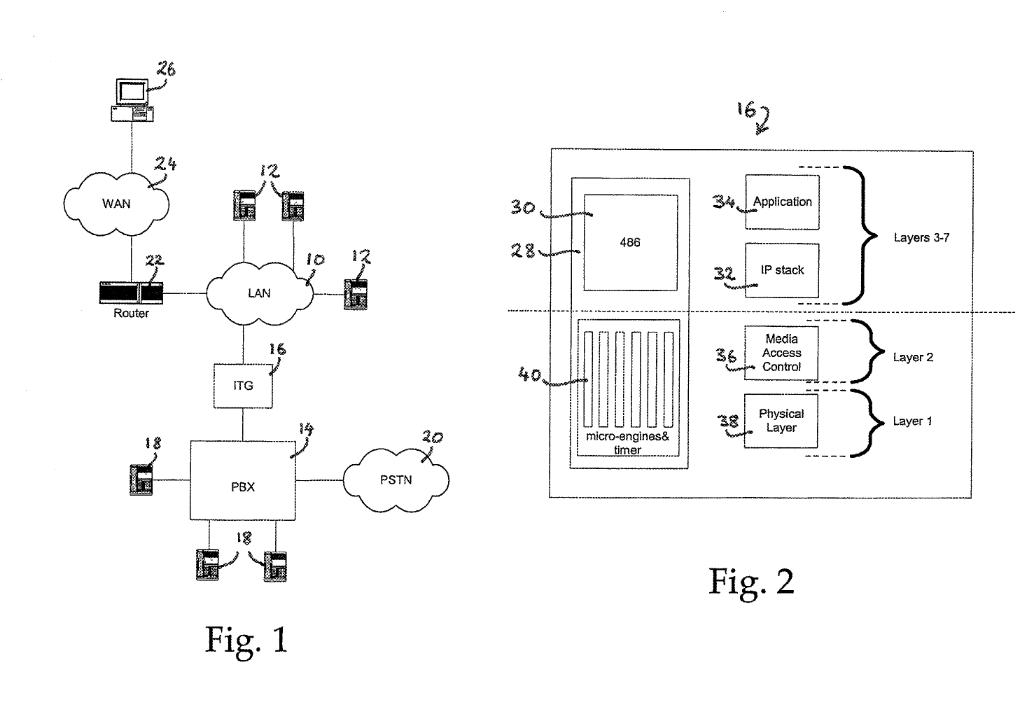

FIG. 1 shows an IP (internet protocol) telephony system architecture in which the present invention is implemented. It is to be understood that the invention is not limited to IP telephony applications and is suitable for implementation in other applications. In particular the invention is suitable for use in relation to devices, systems and networks in which an error in a protocol stack may cause a component to malfunction or in which diagnosis of the operation of a component may be desirable without accessing the higher levels of the protocol stack.

In the system shown in FIG. 1, a local area network (LAN) 10 is used to carry voice and other telephony data, along with non-telephony data using the TCP/IP standard carried over Ethernet or other layer 2 protocol. The LAN connects a plurality of Ethernet IP handsets 12 (which each include an IP stack for converting voice signals to packets, which in turn are included in Ethernet frames for transmission across the network to another system component). A private branch exchange (PBX) 14 such as the Meridian M1 PBX sold by Nortel Networks is connected to the LAN 10 using an internet telephony gateway (ITG) card 16.

ITG 16 is shown separate from the PBX, but in practice the ITG will be integrated into many PBX systems as e.g. a plug-in card containing the necessary hardware and firmware to perform ITG functions. The ITG operates by translating between the packets (or more accurately the Ethernet frames) carried on the LAN and the proprietary time division multiplexed (TDM) signals employed in the PBX backplane.

PBX 14 has a number of conventional (non-IP) handsets connected to it which can be used to make calls to one another or to access external number via the PBX 14 and the public switched telephone network (PSTN) 20. The ITG provides functionality allowing the conventional handsets to dial one of the Ethernet sets 12 with number translation being provided by the PBX, to allow directory numbers assigned by the PBX to handsets 12 to be translated to IP addresses.

Finally, LAN 10 is connected via a router 22 to a wide area network (WAN) 24 such as a company intranet or the Internet. A personal computer 26 is shown connected to WAN 24;

in reality there will be large numbers of computers and other devices (including other PBXs and handsets) connected to WAN 24. Similarly, FIG. 1 shows only a single PBX 14 and three handsets 12 connected to the LAN 10, but there may be a large number of individual PBXs, each with multiple handsets 18, and a large number of Ethernet sets 12, with a gatekeeper providing management of the IP telephony network.

The system thus far described is a conventional or known IP telephony system with which the skilled person will be familiar. However, in addition to the IP stack and ITG functions described above, the invention provides additional functionality to the protocol stacks embodied in the ITG and the Ethernet handsets.

FIG. 2 is a diagram illustrating the main hardware components and functional aspects of the firmware or software held on the ITG card 16. The hardware implementation is a chip set 28 including a core processor 30 which is an Intel 486 processor in this embodiment. Other chips such as an Intel Pentium chip (Intel and Pentium are Trade Marks of Intel Corporation) or a Motorola 86000 (Motorola is a Trade Mark of Motorola Inc.) can be used. The core processor 30 performs the functions of the TCP/IP protocols and higher layers of the protocol stack 32. In terms of the theoretical OSI 7 layer model, the TCP/IP stack 32 is in layers 3 and 4, and the application software 34 is in layer 7. The application may provide a graphical user interface allowing control of the internet telephony functions, and automated call control, codec selection, etc.

The media access control (MAC) layer 36 (or data link layer, the terms being used interchangeably herein) in layer 2 receives IP packets and assembles them in Ethernet frames (or if other media access protocols are used, in the appropriate format). The functions of layer 2 and of the physical layer 38 (layer 1) are carried out by a set of microengines 40 (smaller dedicated processing, such as the Intel IXP1200 (Trade Mark), used for discrete tasks such as MAC layer processing) which in the present embodiment are physically distinct from the core processor 30. The functions of layer 2 can also be carried out by processor 30, though it is preferred for reasons of speed and stability to have a separate silicon architecture for layer 2.

The microengines of the present embodiment are programmed with additional functionality to enable them to carry out instructions contained in packets received from physical layer 1 without passing the packets to layers 3 and above in the normal way. Such packets (or frames) contain a distinguishing feature which is recognised at layer 2 causing the layer 2 microengines to examine these packets, determine an instruction from them, and then carry out a task specified in the instruction.

Because the microengines can write directly to registers of the processor 30, the tasks carried out can have a fundamental affect on the operation of the card 16. For example, most processors have registers in which setting a particular bit to “1” causes the processor to reboot or to terminate a running application. In this way, when it is determined that card 16 is malfunctioning, a remote instruction contained in a special Ethernet frame can be used to restart the device or terminate a running process which is suspected to give rise to the problem.

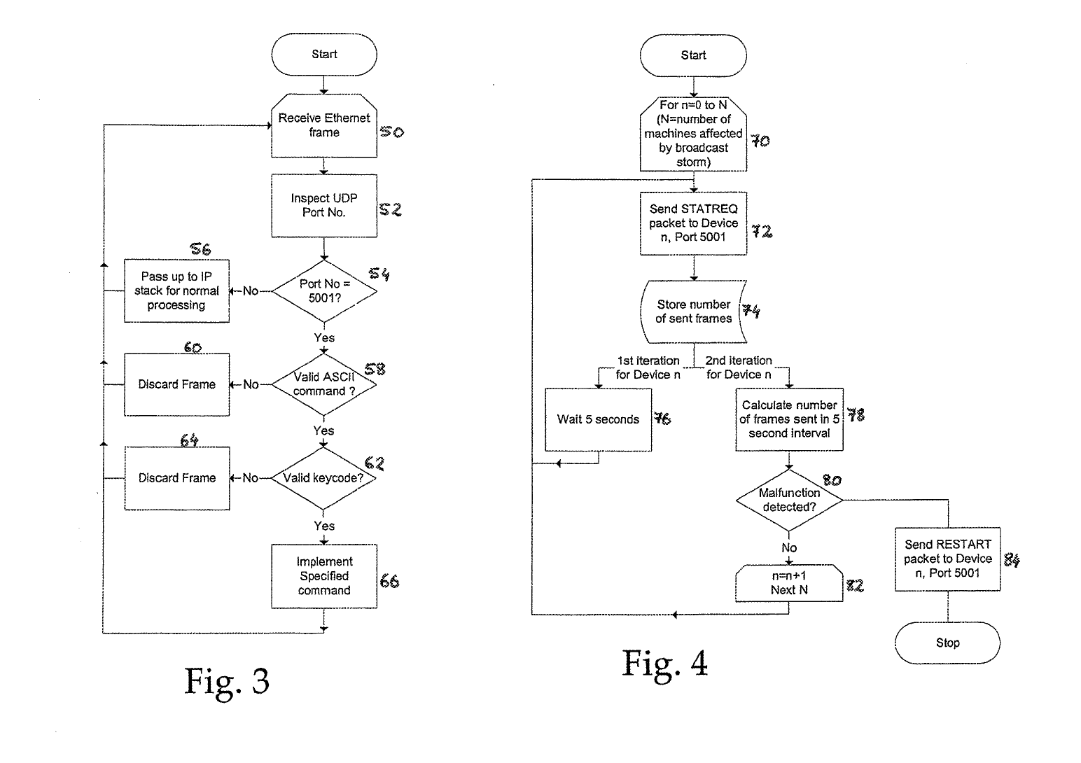

FIG. 3 illustrates this method in operation in a simple embodiment. The flowchart of FIG. 3 shows the operation of the layer 2 firmware in general terms. The microengines 60 include means for inspecting received Ethernet frames, comparing particular sections of the frames with stored data, and carrying out a particular task such as writing to a predetermined register bit.

In step 50, a frame is received at layer 2 via layer 1 over the network from a remote device such as PC 26 (FIG. 1). Layer 2 examines this frame, step 52 to determine the port number to which its data is addressed. Normally, the packet will simply be passed up to layer 3, and processed before being passed to the relevant process specified in the port number. However, the layer 2 components are programmed to recognise particular port numbers as being indicative of a frame including a direct layer 2 instruction. In the present case, the port number 5001 is specified as being such a characteristic port number (obviously it is important that if the port number is used as in identifier of an instruction, then the port number chosen must not be one available to the normal processes running on the main processor 20).

If it is determined, step 54, that the port number is not 5001, then the packet is processed in the normal way, i.e. passed up to the TCP/IP stack, step 56, and the next frame awaited (or the next outgoing packet is included in an Ethernet frame for transmission).

If the port number is 5001 (or whatever port number is used as an indication of a special instruction to layer 2, the payload of the frame is inspected to determine whether there is a valid command string, step 58. It is envisaged that a number of instructions are programmed into layer 2, but this step can be omitted if receipt of a packet indicated as being a command is always indicative of the fact that a single action is to be performed.

Where multiple commands are available, the command string may be human readable as an ASCII string, such as RESTART or PORT-STOP, but this is not required. If the command string is not recognised, the frame is discarded, step 60.

Further safeguards may be built into the system, such as a keycode included in the frame containing a confirmation code to ensure that the packet is operated on only by the correct device, or to ensure that the packet genuinely originated from a machine authorised to instruct the requested action. The keycode can be a unique secret key stored in the memory of card 16 and known only to the administrator. Alternatively, the keycode can be a timestamp, as a less comprehensive method of validating the fact that the frame is a current and valid instruction to perform the requested action. Further safeguards and checks will be apparent to the skilled person. If the keycode is determined not to be valid, step 62, the frame is discarded, step 64.

If however, all of the checks are satisfied the microengines are programmed to take some specific action, step 66, which may depend on the particular command string included in the payload of the packet. When this action has been taken (such as writing a bit in a register to cause the processor to take a particular action), the layer 2 firmware awaits the next frame, step 50.

As a specific example of how this method may be advantageously used, consider the situation where a broadcast storm is underway in the section of network shown in FIG. 1 including LAN 10, handsets 12 and ITG 16. In this scenario, the router 22 prevents the broadcast storm from propagating through to WAN 24.

Assuming that an application error in layer 7 of card 16 has caused repeated broadcast packets to be sent from the stack, it may not be apparent to a user at PC 26 whether it is card 16 (or some other ITG card) or any particular one of phones 12 which is the source of the problem. None of the devices may be responsive to remote access methods such as Telnet, due to the fact that the IP stack of each device is fully occupied in processing the 20,000 broadcast packets received from card 16 each second. The malfunctioning IP stack on card 16 similarly prevents any access to diagnostic or control software in layer 7 of card 16, even if it is possible to remotely determine that card 16 is the source of the storm.

FIG. 4 shows the method of operation of a piece of diagnostic software on PC 26. The software is aware of the identity and address of each device on the area of network affected by the broadcast storm. A FOR . . . NEXT loop is initiated in step 70 which successively identifies each of the N devices in the affected network section. The diagnostic software is configured to generate packets addressed to port 5001 of each machine, with the packet payload including the text string STATREQ (denoting “statistics request”), and a keycode as explained above which will be treated as valid by the device in question, step 72.

When the STATREQ packet is received at each device in turn, the process of FIG. 3 is carried out by that device. In other words, the packet is identified (due to the specification of port 5001) as an instruction to layer 2, and the necessary action is taken, which in this case is the preparation and transmission of a frame or series of frames whose payload of data indicates the number of packets sent to date by that device (the statistics are stored in a running register on layer 2 of the device). As alternatives, the statistic may include the number of broadcast requests processed, or the sequence number of the last frame sent (with each frame sent by layer 2 being accorded a sequence number).

The statistic data is received back from device n at step 74 of FIG. 4 and the number of frames transmitted to date by device n is stored in memory. If this is the first time that the process has been conducted for that device, the diagnostic software waits e.g. 5 seconds, step 76, before repeating steps 72 and 74, by which point the memory will include two totals of frames sent by Device n, separated in time by 5 seconds. In this second iteration, the process then proceeds to step 78 and the number of frames sent during that 5 second interval is calculated by simple subtraction. The diagnostic software is provided with normal and abnormal ranges of frame/second transmission rates, and checks against these ranges for an abnormal level of activity, step 80 (or if the statistics received relate only to the number of broadcasts from device n, an abnormal amount of broadcast activity).

If the device in question appears to be acting normally, the program increments to the next device, step 82, and repeats until a device is found in step 80 to be malfunctioning (i.e. is the source of the broadcast storm). The software then prepares a further packet to send to the device in question, identifying port 5001 (so that in the FIG. 3 process layer 2 of device n will treat this as a direct instruction packet) and including the command RESTART, step 84. At this point the remote diagnostic process of FIG. 4 terminates.

The effect of this RESTART command is to cause layer 2 of the remote device to write a bit to a restart register of the processor 30. When this bit is set to “1”, then in known manner, the process terminates running processes and reboots. This has the effect of ending the broadcast storm and allows the rest of the network to operate as normal. The reboot may automatically set running the processes necessary for the affected device to log on to the network, or manual intervention may be required, but in either case, the immediate problem is solved and the remote diagnostic software contains a log of the malfunctioning device.

Because the layer 2 hardware and software is often more robust than that of the higher layers, and because in particular the preferred embodiment of ITG card has a physical separation between the processors responsible for layer 2 task and for higher layer tasks, the method of the invention allows direct intervention in cases where a malfunction in a higher layer prevents remote access to the device in the normal way.

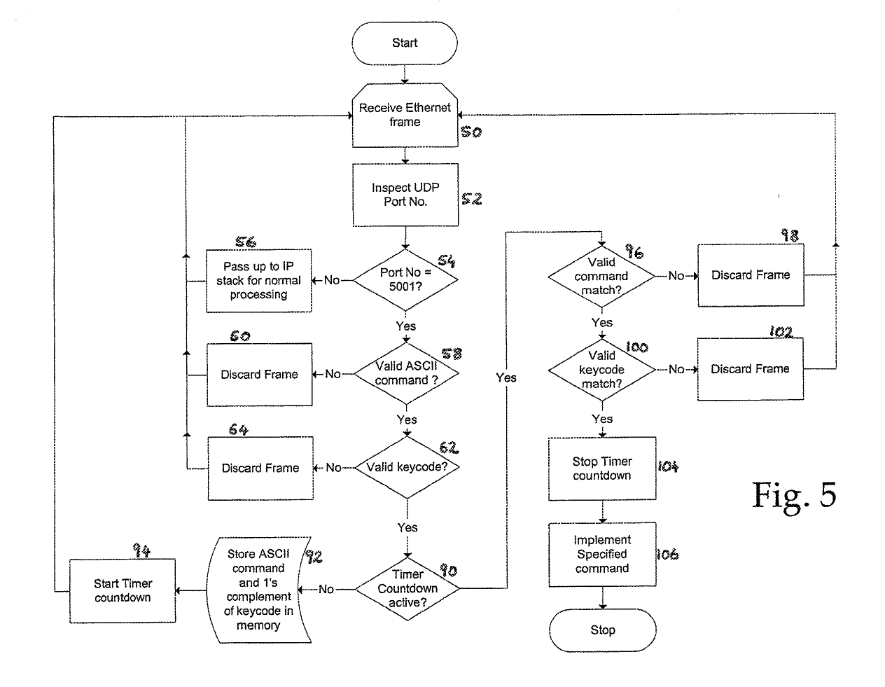

FIG. 5 shows a more sophisticated version of the method of FIG. 3. Recognising that remote restarts of critical systems should not be lightly undertaken, the process of FIG. 5 has a greater degree of security and error-proofing built in.

The process of FIG. 5 is identical from step 50, when a frame is received through to steps 62 and 64 when a determination is made that a keycode is invalid and the frame is discarded. If in step 62, the keycode is determined to be valid, then rather than implementing the identifying command, the layer 2 microengines determine whether a dedicated countdown timer is already active in the microengines, step 90. When the first instruction packet is received, this tinier will not be active.

The keycode in this embodiment is a binary number. To avoid the situation where a malfunctioning device starts to erroneously generate remote RESTART commands according to the invention, the process of FIG. 5 stores the one's complement of the received keycode, along with the command in memory, step 92. The purpose of this is to allow recognition of a valid confirmation command packet which will contain as a keycode this stored one's complement (rather than the original keycode or a new valid timestamp, either of which might occur if the remote instructing device was malfunctioning by sending commands at random).

Once the command and the complement of the keycode are stored, a countdown timer (of e.g. ten seconds duration) is started, step 94, and the next frame awaited. Other frames will typically be received during this ten second period, but will be ignored. When the next valid command frame is received, however, as finally determined in step 62, the layer 2 process notes that the timer is active, step 90, and checks to see that the command string is a valid confirmation of the stored command, step 96.

As an example, the initial command RESTART might be followed by the confirmation _RESTART. Other examples of command-confirmation pairs would include [STATREQ, _STATREQ] (as explained previously to obtain transmission or other operating statistics available to layer 2, [PORT-STOP,_PORT-STOP] (to close a port from which it has been determined or it is suspected that problematic traffic is originating), [PORT-START, _PORT-START (to reverse the PORT-STOP action). The PORT-STOP or PORT-START commands may specify a particular port number, or may be used generically to close all ports currently in use on the device. They may operate by causing alterations in the MAC registers relating to the ports.

Other commands can of course also be used in the scope of the present invention, if they specify an action which can be taken at the data link layer to influence the operation of the device in question.

If the command does not confirm the earlier command, then the frame is discarded, step 98. If it is a valid match, then the keycode of the confirmation frame is examined to ensure that the instructing device correctly used the one's complement of the original keycode, step 100, and if this is not the case the frame is discarded, step 102.

When a confirmation is correctly validated in steps 96 and 100, the timer countdown is stopped, step 104 and the confirmed command is implemented as appropriate, step 106.

The invention is not limited to the embodiments disclosed herein which may be departed from or varied within the scope of the claimed invention.

What is claimed is:

1. A method of operating a network device having a communications protocol stack for communication with other devices via a packet-based network, the protocol stack including at least a media access layer and one or more higher layers, said method comprising:
receiving a packet at the media access layer of the device;
analysing said packet to identify a characteristic indicative that the packet includes a media access layer instruction; and
upon identification of said characteristic, executing a procedure at the media access layer in accordance with the instruction contained in the packet without passing said packet to a higher layer.

2. A method as claimed in claim 2, wherein said procedure for execution comprises writing one or more bits to a register of the device.

3. A method as claimed in claim 3, wherein writing said bit(s) causes a processor of the device to vary the operation of the device.

4. A method as claimed in claim 3, wherein the operation of the device is varied by the processor executing a device restart.

5. A method as claimed in claim 3, wherein the operation of the device is varied by the processor stopping the transmission of packets from the protocol stack.

6. A method as claimed in claim 3, wherein the operation of the device is varied by the processor terminating an executing application procedure running on the device.

7. A method as claimed in claim 3, wherein the operation of the device is varied by the processor jumping to a different instruction of an executing application procedure running on the device.

8. A method as claimed in claim 1, wherein said method is repeated to identify a pair of related packets each containing a media access layer instruction, such that identification of the first packet of the pair causes the media access layer of the device to execute a procedure of awaiting the second packet of the pair, and wherein identification of the second packet causes the media access layer to execute a further procedure, whereby both packets of the pair must be received for the further procedure to be executed.

9. A method as claimed in claim 8, wherein said awaiting procedure comprises starting a timer and monitoring received packets to identify said second packet before a predetermined timeout period has elapsed.

10. A method as claimed in claim 1, wherein said characteristic indicative that the packet includes a media access layer instruction is a port number not corresponding to an open port of the device.

11. A method as claimed in claim 10, wherein said port number is a predetermined port number used exclusively as said characteristic indicator.

12. A method as claimed in claim 1, wherein said characteristic is an instruction readable by the media access layer and contained in the datagram of the packet.

13. A network device comprising:
a communications protocol stack for communication with other devices via a packet-based network, the protocol stack including at least a media access layer and one or more higher layers,
said media access layer comprising a discrimination module for discriminating between received communications packets for passing to a higher layer and received instruction packets for processing at the media access layer on the basis of a characteristic indicative that the packet includes a media access layer instruction; and
said media access layer further comprising a processing circuit for processing instructions received in instruction packets to thereby vary the operation of the device without passing said instruction packets to a higher layer.

14. A network device as claimed in claim 13, wherein said processing circuit is operatively linked to a register of the device, wherein changing a value of the register causes a variation in the operation of the device.

15. A network device as claimed in claim 13, further comprising a timer circuit in communication with the discrimination module, whereby the discrimination module can measure the time between receipt of a pair of packets each containing a media access layer instruction.

16. A computer program product comprising instructions for execution on a network device having a communications protocol stack for communication with other devices via a packet-based network, the protocol stack including at least a media access layer and one or more higher layers, said instructions, when executed on said device being effective to cause the device to:
analyse a packet received at the media access layer of the device to identify a characteristic indicative that the packet includes a media access layer instruction; and
upon identification of said characteristic, execute a procedure at the media access layer in accordance with the instruction contained in the packet without passing said packet to a higher layer.

17. A method of diagnosing a network device having a communications protocol stack for communication with other devices via a packet-based network, the protocol stack including at least a media access layer and one or more higher layers, said method comprising:
sending a packet to the network device via the network, said packet including a media access layer instruction to which the media access layer is responsive, said instruction causing the media access layer to automatically issue to a remote address on the network a response including information for use in a diagnosis of the device;
receiving at said remote address said response from the device; and
analysing said information to diagnose the network device.

18. A method as claimed in claim 17, wherein said information in said response comprises a traffic report relating to outbound traffic from the device.

19. A method as claimed in claim 18, wherein said step of analysing comprises determining if the volume of outbound traffic from the device is greater than a predetermined limit.

20. A method as claimed in claim 17, further comprising repeating the steps of the method in respect of a plurality of devices on the network.

21. A method of diagnosing a network device having a communications protocol stack for communication with other devices via a packet-based network, the protocol stack including at least a media access layer and one or more higher layers, said method comprising:
sending a first packet to the network device via the network at a first time and a second packet to the network device at a second, later time, said packets each including a media access layer instruction to which the media access layer is responsive, said instructions causing the media access layer to automatically issue to a remote address on the network a response to each packet including information for use in a diagnosis of the device;
receiving at said remote address a response from the device to the first packet and a response to the second packet; and
analysing the information in said responses to diagnose the network device based on the change in information between the first and second responses.

22. Apparatus for diagnosing a network device, wherein the device being diagnosed has a communications protocol stack for communication with other devices via a packet-based network, the protocol stack including at least a media access layer and one or more higher layers, said apparatus comprising:
a packet generator for generating a packet including a media access layer instruction to which the media access layer of the network device is responsive, said instruction being adapted to cause the media access layer to automatically issue to a remote address on the network a response including information for use in a diagnosis of the device;
a memory for capturing at said remote address said response from the device; and
a processor for analysing said information to diagnose the network device.

23. A computer program product comprising instructions for execution on a diagnostic apparatus for diagnosing a network device having a communications protocol stack for communication with other devices via a packet-based network, the protocol stack of the network device including at least a media access layer and one or more higher layers, said instructions, when executed on said diagnostic apparatus being effective to cause the device to:
sending a packet to the network device via the network, said packet including a media access layer instruction to which the media access layer is responsive, said instruction causing the media access layer to automatically issue to a remote address on the network a response including information for use in a diagnosis of the device;
receive at said remote address said response from the device; and
analyse said information to diagnose the network device.

24. A method of remotely controlling a device over a network, the device having a communications protocol stack for communication with other devices via a packet-based network, and the protocol stack including at least a media access layer and one or more higher layers, wherein the method comprises:
generating a packet including a media access layer instruction for interpretation by the media access layer of the network device and a characteristic indicative to the media access layer that the packet includes an instruction for interpretation by the media access layer; and
sending said packet to said network device.

25. Apparatus for remotely controlling a network device having a communications protocol stack for communication with other devices via a packet-based network, and the protocol stack including at least a media access layer and one or more higher layers, wherein the apparatus comprises:
a packet generator for generating a packet including a media access layer instruction for interpretation by the media access layer of the network device and a characteristic indicative to the media access layer that the packet includes an instruction for interpretation by the media access layer; and
a network connection for sending the packet to the network device.

26. An electrical signal comprising a packet for transmission across a packet-based network, said packet including an instruction for interpretation by the media access layer of a receiving device effective to cause said media access layer to execute a procedure without passing said instruction to a higher layer.

27. A packet based network comprising a network device, said network device comprising:
a communications protocol stack for communication with other devices via a packet-based network, the protocol stack including at least a media access layer and one or more higher layers,
said media access layer comprising a discrimination module for discriminating between received communications packets for passing to a higher layer and received instruction packets for processing at the media access layer on the basis of a characteristic indicative that the packet includes a media access layer instruction; and
said media access layer further comprising a processing circuit for processing instructions received in instruction packets to thereby vary the operation of the device without passing said instruction packets to a higher layer.

28. A packet-based network as claimed in claim 27, further comprising a diagnostic apparatus for diagnosing said network device, said apparatus comprising:
a packet generator for generating a packet including a media access layer instruction to which the media access layer of the network device is responsive, said instruction being adapted to cause the media access layer to automatically issue to a remote address on the network a response including information for use in a diagnosis of the device;
a memory for capturing at said remote address said response from the device; and
a processor for analysing said information to diagnose the network device.
